(19) United States
(12) Patent Application Publication
(10) Pub. No.: US 2006/0247994 A1
(43) Pub. Date: Nov. 2, 2006

(54) Method and system for operating a financial instrument

(76) Inventor: Mark Laycock, London (GB)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/341,014

(22) Filed: Jan. 27, 2006

Related U.S. Application Data
(63) Continuation-in-part of application No. 10/098,678, filed on Mar. 14, 2002, now abandoned.

(30) Foreign Application Priority Data
Mar. 14, 2001 (GB) 0106314.8

(51) Int. Cl. G06Q 40/00

(52) U.S. Cl. 705/35; 705/38

(57) ABSTRACT

A company issues an instrument including a claim upon its assets whose priority in the event of bankruptcy or liquidation varies as a result of one or more specified qualifying events which may be experienced by the company. The claim takes the form of a security which in its initial form is a bond or some other instrument evidencing debt. Following the occurrence of one of the specified events the claim is transformed into a claim upon the company which has a lower level of seniority in the event of bankruptcy or liquidation than the original form of the claim, for example an equity instrument.

### CROSS-REFERENCE TO RELATED APPLICATIONS

This application claims the benefit of and priority to British Patent Application No. 0106314.8, filed 14 Mar. 2001. This application is a continuation-in-part application of U.S. patent application Ser. No. 10/098,678, titled Method and System for Operating a Financial Instrument, filed Mar. 14, 2002, the contents of which are herein incorporated by reference in their entirety.

### BACKGROUND OF THE INVENTION

Various catastrophe financial products are known. These financial instruments are normally issued in the form of debt. When an event described in the prospectus occurs then the claim evidenced by the debt is extinguished and the issuer keeps the cash representing principal and/or interest. Examples include earthquake bonds where the trigger for conversion might be the recording of an event over a certain level on the Richter Scale for a particular geographic region, such as California.

### SUMMARY OF THE INVENTION

The present invention is directed to a financial instrument which can be issued by or on behalf of a company. In general terms the invention proposes that a company issues a claim upon its assets which varies as a result of one or more specified events which may be experienced by the company. The claim takes the form of a security that in its initial form is a bond or some other instrument evidencing debt. Following the occurrence of one of the specified events the instrument is transformed into a claim upon the company that has a lower level of seniority in the event of bankruptcy or liquidation than the original form of the claim upon the company, for example some form of equity instrument. Thus, by contrast with the known catastrophe financial products mentioned above, investors get an instrument which changes seniority claim in the event of an operating problem, rather than losing all claims on the assets of the company. While the invention herein is discussed with reference to changed seniority, it will be appreciated that the change in the instrument may also be one of change from secured to unsecured status. Specifically, the invention processes a method of operating a financial instrument associated with a company, the method including:
issuing a financial instrument including a first claim on the company at a first seniority level, the financial instrument being associated with a predefined future time period and with one or more specified operational risk events which the company may experience during the period;
upon one of the specified events occurring during the period, the first claim being transformable to a predefined second claim having a second seniority level lower than the first seniority level.

The transformation itself may occur automatically upon one of the specified events occurring, but more preferably it occurs as a result of a decision made, following one of the specified events occurring, by the issuer of the instrument, by the company, or an entity associated with the issuer or company, rather than being transformable at the option of the purchaser of the instrument.

The specified events belong to a class of events described here as “operational risk events”, and the first claim is referred to as a “contingent equity for operational risk events” or CEORE. “Operational risk” is a term known in the financial industry, where a favoured definition is “the risk of direct or indirect loss resulting from inadequate or failed internal processes, people and systems or from external events”. Operational risk events include, for example, problems with staff and organisation, relationships with other companies (particularly counterparts in commercial relationships), legal risk, technology, external environment problems, and disasters such as “acts of God”. The events preferably do not include any of the following events which we do not regard as operational risk events: a change in price of debt or equity instruments or claims, foreign exchange rates or their various derivatives, nor business or strategic events such as marketing strategies.

Strategic and reputational risk are not included in the regulatory definition of operational risk but it does include legal risk. For regulatory purposes Legal Risk is described as the risk that contracts cannot be enforced due to incomplete documentation or concerns about the legal capability of a client and a number of other aspects and includes, for example, but is not limited to exposure to fines, penalties, or punitive damages resulting from supervisory actions, as well as private settlements. The following are examples of various levels of event type categories which may be considered as examples of Legal Risk:
Internal Fraud (level 1)—which may be considered to comprise, for example, losses due to acts of a type intended to defraud, misappropriate property or circumvent regulations, the law or company policy, excluding diversity discrimination events, which involves at least one internal party.
Unauthorised Activity (level 2)
Theft & Fraud (level 2)
External Fraud (level 1)—which may be considered to comprise, for example, losses due to acts of a type intended to defraud, misappropriate property or circumvent the law by a third party
Theft & Fraud Systems (level 2)
Security (level 2)
Employment Practices & Workplace Safety (level 1)—which may be considered to comprise, for example, losses arising from acts inconsistent with employment, health or safety laws or agreements, from payment of personal injury claims, or from diversity/discrimination events.
Employee Relations (level 2)
Safe Environment Diversity & Discrimination (level 2)
Clients, Products &Business Practices (level 1)—which may be considered to comprise, for example, losses arising from an unintentional or negligent failure to meet a professional obligation to specific clients (including fiduciary and suitability requirements), or from the nature or design of a product.
Suitability, Disclosure & Fiduciary (level 2)
Improper Business or Market Practices (level 2)
Product Flaws (level 2)
Selection, Sponsorship & Exposure (level 2)
Advisory Activities (level 2)
Damage to Physical Assets (level 1)—which may be considered to comprise, for example, losses arising from a loss or damage to physical assets from natural disaster or other events.
Disasters and other events (level 2)
Business Disruption and System Failures (level 1)—which may be considered to comprise, for example, losses arising from disruption of business or system failures.
Systems (level 2)
Execution, Delivery &Process Management (level 1)—which may be considered to comprise, for example, losses from failed transaction processing or process management, from relations with trade counterparties and vendors.
Transactions, Capture, Execution & Maintenance (level 2)
Monitoring & Reporting (level 2)
Customer Intake & Documentation (level 2)
Customer/Client Account Management (level 2)

Consideration is being given to using two dimensions to define operational risk for regulatory purposes, the effects and the events. Of these, at this time, the effects are better defined than the events. The effects include:

1. Write-downs: direct reduction in value of assets due to theft, fraud, unauthorised activity or market and credit losses arising as a result of operational events;

2. Loss of Recourse: payments or disbursements made to incorrect parties and not recovered;

3. Restitution: payments to clients of principal and/or interest by way of restitution, or the cost of any other form of compensation paid to clients;

4. Legal Liability: judgements, settlements and other legal costs;

5. Regulatory and Compliance (inc. Taxation Penalties): fines, or the direct cost of any other penalties, such as license revocations;

6. Loss of or Damage to Assets: direct reduction in value of physical assets, including certificates, due to some kind of accident (e.g. neglect, accident, fire, earthquake).

The event categories are poorly described at present and industry consensus is being created, however the labels currently in use include:
Employees & Staff;
Third Parties including customers, legal risk issues, criminal actions,
Technology including computers—hardware and software,
Assets including physical and intellectual, Acts of God and Man; and
External or Other Stakeholders including, politicians, tax, social expectations, etc. For the event categories, these headline labels although intuitive do not provide much clarity. The scope will be provided by more detail further down the event hierarchy. For that reason we propose here that the events or the risks covered by the instrument are described in a prospectus for the instrument. The instrument could address the entire events x effect matrix, or it could address for the instrument one cell in the matrix.

The method normally includes a verification process, e.g. by involving an independent third party, confirming that an operational risk event as described in the prospectus has occurred. Following this verification the event is referred to as a “qualifying” operational risk event.

For the company issuing such an instrument the advantage is that if one of the specified events occurs the company has access to additional equity. This flexibility facilitates the optimisation of the return on equity for shareholders. For some classes of company, for example some types of financial institution, this flexibility could have significant value when viewed alongside regulatory capital requirements for operational risk events.

The term “company” as used in this document is used in a general sense to include not only a single legal entity but also any commercial undertaking, such as a group of associated incorporated bodies or even a partnership.

The term “seniority” of a claim is used herein to mean the priority of the claim in the event of a liquidation, bankruptcy or court ordered winding up of the affairs of a company. In such a case there is a hierarchy of creditors who each have a claim on the assets of the company. Thus, there is a “schedule” of the priority of claims upon the assets of a company or individual in the event of a liquidation, bankruptcy or other similar event. The schedule may, for example, be structured as follows:

1. Fixed Charge Holders—holders of mortgages over properties, debentures secured on specific assets, hire-purchase agreements etc. Such claims are met from the proceeds arising from the sale of the assets.

2. Preferential Creditors—this generally includes government—local and national—agencies and includes, for example, the Internal Revenue Service, Social Security Administration, state unemployment compensation agencies, and local and regional taxing authorities.

3. Floating Charge Holders—this category have claims over the floating assets such as stocks, inventory and work-in-progress.

4. Unsecured Creditors—are all other creditors who will only receive payment from any surpluses from the three classes with a higher priority of claim on the assets of the firm.

5. Shareholders—this group will receive any proceeds remaining after the other classes of claims have been met.

In addition, there may be instruments evidencing claims that are between these various categories, for example Junior Preference Shares. In some cases the name of the claim may relate to a specific industry such as finance even though it has all of the features of one of classes of claims described above, for example Subordinated Debt has a status which is very similar to Unsecured Creditors.

Although the invention has been defined above as a method of issuing an instrument, it may alternatively be defined as a method or computer system which values the instrument based on statistical information about the likelihood of operating risk events, and full information about the terms of the instrument.

### BRIEF DESCRIPTION OF THE FIGURES

Exemplary embodiments of the invention and preferred features will now be described in detail for the purpose of illustration only, with reference to the following figures:

FIG. 1(a) depicts a timeline and the structure of a first claim according to a representative embodiment of the present invention.

FIG. 1(b) depicts a timeline showing the transformation of the first claim of FIG. 1(a) into a second claim, according to a representative embodiment of the present invention.

FIG. 2 illustrates the currency value of operational risk events as a function of a parameterized characterization of the transformation of FIG. 1(b) according to a representative embodiment of the present invention

### DETAILED DESCRIPTION OF THE EMBODIMENT

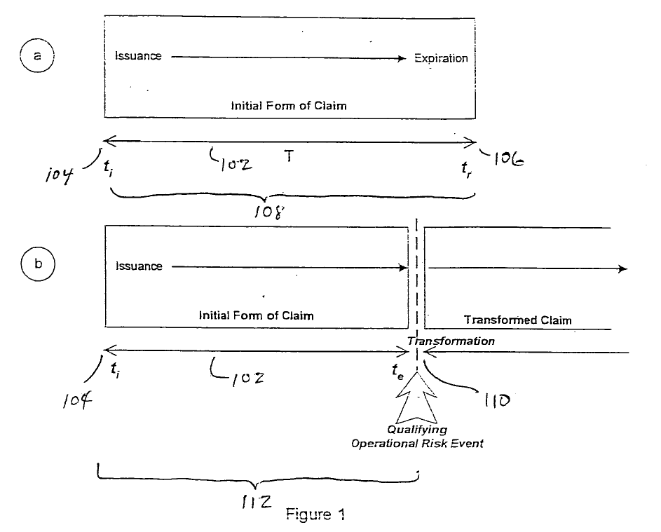

FIGS. 1(a) and 1(b) show the transformation as a function of time of a first claim, shown in FIG. 1(a) into a second claim, as shown in FIG. 1(b), due to the occurrence of an operational risk event. The horizontal axis 102 shows time passing from left to right.

The initial claim or instrument is issued at t_{i 104} as a form of debt that expires and is redeemed at t, 106, with a time to expiration of T=(tᵣ−tᵢ) indicated by 108. If no qualifying operational risk event takes place prior to t, 106, then the instrument expires at t_{r 106} and is redeemed in accordance with the terms of the prospectus or agreement between the parties. This can be seen in FIG. 1(a).

However, if there is a qualifying operational risk event, at t_{e 110}, then the instrument or claim is transformed. This can be seen in FIG. 1(b). The time to the qualifying operational risk event can never be beyond the time to expiration of the initial claim or instrument, i.e. tₑ−tᵢ (indicated by 112)<tᵣ−tᵢ (indicated by 108).

The transformation of the claim upon the company is governed by the terms in the prospectus relating to the instrument. Such terms may include one or more of the following—the term of the initial form of the claim, conditions under which the initial claim is transformed into another form, and the term of the transformed claim.

The operational risk events can be put into broad classes such as Staff & Organisation, Relationships, Technology, External Environment, and Disasters. These classes include IT failures, criminal actions against the company (direct or indirect) by individuals employed by the company or independent of the company, and Acts of God such as Earthquakes. Each event has a “size” (e.g. a quantification of the loss suffered by the company as a result of the event), and the event only qualifies if its size is above a minimum size associated with that type of event; for example there may be a minimum size for each respective class of event. For each instrument issued the related prospectus, describing the terms and conditions, would contain a description of the operational risk events which qualify to trigger the transformation of the claim or instrument, including the minimum and maximum sizes of those events.

The details of the events surrounding the determination of a qualifying operational risk event will be described in the prospectus of the CEORE. Once the company has identified a potentially qualifying operational risk event then the event must be verified, possibly by an independent third party, for the event to be classified as a qualifying operational risk event. The verification process will address two aspects, the first is that the event corresponds to the range of events, or causes of events described in the prospectus. The second aspect is that the event is of a given size. The potential qualifying operational risk event must meet both criteria in order to become a qualifying operational risk event. Auditors—external or internal to the company, consultants, or other individuals may perform the independent verification or other companies or individuals deemed to be suitably qualified, for example insurance loss adjusters. The time for the verification that a qualifying operational risk event has occurred will be specified in the prospectus and will normally be less than two weeks. (Two weeks is assumed to be the maximum time that the regulators of financial firms will permit for the CEORE to be treated as a mitigant of the operational risk faced by one of these firms.)

The transformed claim will have lower seniority than the initial claim in the event of bankruptcy or liquidation. For example, the initial claim may be in the form of a bond and the transformed claim may be in the form of equity such as common shares.

By transforming the more senior claim into a lower claim the company does not have the credit or liquidity risks that would arise if it asked investors for additional funds. Such a risk might arise if the company issued options or warrants that gave the company the right to seek funds from investors should a qualifying operational risk event occur and the investors were reluctant or unable to provide the additional funds.

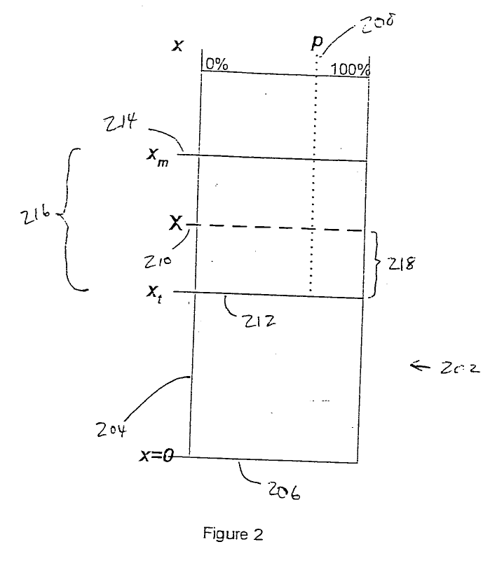

Upon the determination that a qualifying operational risk event has occurred there are a number of choices over the size of the transformation of the initial claim. The transformation could be for the entire proceeds of the initial sale of the initial claim, or the transformation could be for the portion of the claim over a trigger, as shown in FIG. 2. FIG. 2 depicts a graph 202. In the figure the vertical axis (x-axis) 204 indicates the currency value of qualifying operational risk events. The horizontal axis 206 indicates another independent variable characterizing the transformation: a parameter p, e.g., the value indicated at 208 which is a linear proportionality constant relating the value of the transformation to the value of the event which caused it. The proportionality may be linear.

A given operational risk event will have an associated currency value X indicated at 210. For operational risk event to be a qualifying operational risk event the associated currency value must be greater than the trigger Xₜ 212 for the transformation, X>xₜ. In the event that the currency value of the operational risk event, X, is greater than a cap xₘ 214, then the value of the transformation will be limited to xₘ−xₜ 216. For example, if the currency value of an event, X, was $100, the trigger, xₜ, was set at $50, and the cap, xₘ, was set at $75, then the value of the transformed claim would be $25. The benefit xₘ−xₜ 216 from the transformation into a lower status claim should at most be the monetary receipts or proceeds V_{ic} from the original sale of the initial claim by the issuing company.

If the currency value of the qualifying operational risk event, X 210, is less than the cap, xₘ 214, then there is a choice between limiting the transformation to the extent of X−xₜ 218, or transforming the entire claim irrespective of X−xₜ 218, in a binary or digital reaction. The value of the transformation in this case is less than the currency receipts V_{ic} at the time of issue of the initial claim.

When the value of the transformation Vₜ=X−xₜ is less than the maximum of xₘ−xₜ 216 for example 40% of the maximum, there are a number of choices. One choice is pro rata for each individual initial claim that was issued for example to transform 40% of each initial claim. An alternative is to select individual initial claims by ballot or other sampling process from the pool of securities evidencing the initial claim. The prospectus will have to define which choice is used.

The prospectus will also have to define the treatment of the remaining initial claims or residual untransformed portion of xₘ−xₜ. One choice is to prevent any untransformed portion from being transformed even if there are subsequent qualifying operational risk events before the redemption date of the initial claim, tᵣ. Alternatively, the initial claims remain valid with a reduced cap, xₘ*, where xₘ−xₘ* is the value of the initial claim that has been transformed, until xₘ*=xₜ. That is xₘ*

should not be lower than x_{t.} 212.

A generalisation of the above example is for the value of the transformation to be linked to a percentage, p, of the event size. The above example corresponds to the case of p=100%. If a percentage of the size of the qualifying operational risk event is used then the (xₘ−xₜ)*p=V_{ic}.

At transformation, a portion, possibly 100%, of the initial claim is converted in the transformed claim, for example debt into equity. The currency value of the transformed claim is established, as above. The number of units of the securities representing the transformed claim, for example common shares, will be determined by a formula. The number of units n=Vₜ/I. The index/(expressed as a monetary value) may vary according to the exact nature of the transformed claim, for example equity that is already traded, or some other security such as new issue of junior preference shares. In the case of traded equity the index could be based upon the price on one particular nominated day or as an average over a number of days, or some other mechanism specified in the prospectus.

The transformed claim may have related options, see below on pricing and valuation. Such options may give the holders of the transformed claim the right to sell the transformed claim to the issuing company or some other third party on a pre-determined date for a specified price or value. The terms of such rights or options will also have to be specified in the prospectus surrounding the initial claim.

The initial claim is a compound security as it has the form of debt instrument with one or more embedded options. The embedded option effects the conversion of the initial claim into the transformed claim.

The embedded options cannot be separated and traded in their own right. If the option element was in the form of warrants (options that can be traded separately) or some other security, then the issuer would have a contingent credit risk. When a qualifying operational risk event occurred the holders of the warrant or other security may not be prepared to provide the funds in a timely manner.

There are a number of components to the valuation of the embedded option. The components include a distribution of the currency value (or some other statistical description) of the potential operational risk events that are in the categories described in the prospectus. There are the values for trigger, xₜ 212, the exercise price of the option, and the cap, xₘ 214, that sets a maximum payout of the option. One or more interest rates will also be required, for example from the period from issuance until redemption of the initial claim, tᵣ−tᵢ.

The option will have one of a number of styles. For example, a style may be based on the concept of “activity”, such that for the option to be exercisable to trigger the transformation, not only must an operational risk event occur at or above the minimum size, but the option must be “active” at that time. For example there may be a “European Style” option which means that the option is only active at one point in time. American Style options may be active continuously between the sale of the initial claim until the redemption of the initial claim. Options which are intermediate between the European and American Styles may be called Bermudan Style options; for example only becoming active a predetermined period of time after the initial sale, but then remaining active until the instrument expires.

Furthermore, the prospectus may specify that the instrument is based on a “Single” or “Multiple” Option. A Single Option would imply that upon the occurrence of a qualifying operational risk event then any portion of the initial claim that remained unutilised could not be used to satisfy any subsequent qualifying operational risk event. A Multiple Option would imply that upon the occurrence of a qualifying operational risk event then any portion of the initial claim that remained unutilised could be used to satisfy any subsequent qualifying operational risk event.

The nature of the option could be a Simple or Compound Option. The Simple Option would transform the initial claim into a security. The Compound Option would transform the initial claim into a security that also had a related option. For example the Compound Option would convert the initial claim into equity and a related option. The related option could be a “Put” option that enables investors to put their holdings in the transformed claim back into the issuer under certain conditions, including the price that they would receive for the transformed claim.

There is an extensive range of possible embedded option structures. Many of these option structures are widely known for options on equities, foreign exchange rates, bonds, interest rates and a range of other claims and assets. However, for CEORE, the underlying driver for the transformation is not the price of an asset or claim, nor a rate, but the likelihood of a predefined operational risk event being experienced by the issuing company. The result of the exercise of the option embedded in the CEORE is the transformation of the initial claim conversion or exchange of one claim, instrument or security for another.

Once a value has been determined for the option that governs the transformation of the initial claim this needs to be reflected in the pricing of the initial claim. The investors or purchasers of the initial claim are writing the option and should be compensated for writing the option that is embedded in the initial claim. The compensation could take a number of forms that will affect the formula used to determine the value of the option(s) embedded in the CEORE. For example if the compensation is in the form of an increased coupon on the debt there is a chance that the option will be exercised before the option writers have been fully compensated. The compensation could thus be embedded in the price of the initial claim, the initial claim could be sold at a discount to the face or nominal value of the initial claim. The discount would then limit the size of the claim which could be met since it dictates the maximum V_{ic}.

The CEORE instruments described above will have to be issued to enable them to be purchased by a third party and provide the issuing company with a benefit. Such issues may be public and listed on the relevant exchange, or they may be private and without a listing. In both circumstances a bank will normally be involved in either the structuring of the instrument and/or the initial distribution of the instrument.

1. A method of operating a financial instrument associated with a company, the method comprising:
providing a computer adapted to store information about at least one specified event which a company may experience during a predefined future time period;
storing at least one specified event on the computer;
establishing the financial instrument to include a first claim on a company at a first seniority level, the financial instrument being associated with the predefined future time period and with one or more stored specified stored events which the company may experience during the period;
upon one of the specified events occurring during the period, transforming the first claim being transformable to a predefined second claim having a second seniority level lower than the first seniority level.

2. A method according to claim 1 in which the specified events comprise at least one of the following operating events (i) staff problems, (ii) organisational problems, (iii) problems in relationships with counterparts to contracts, (iv) problems in relationships with counterparts in commercial arrangements, (v) technology problems, (vi) external environment problems, and (vii) natural disasters.

3. A method according to claim 1 or claim 2 which upon an event occurring which is alleged to be one of said specified events, said transformation is effected only upon verification by an independent party that a qualifying event has occurred.

4. A method according to claim 1 or claim 2 in which the second claim depends upon a value associated with the specified event which has occurred.

5. A method according to claim 3 in which the second claim depends upon a value associated with the specified event which has occurred.

6. A method according to claim 4 in which the difference in respective values of the first and second claims is a function of the value associated with the specified event which has occurred.

7. A method according to claim 4 in which the difference in respective values of the first and second claims is a linear function of the value associated with the specified event which has occurred.

8. A method according to claim 5 in which the difference in respective values of the first and second claims is a function of the value associated with eth specified event which has occurred.

9. A computer-based method of establishing a value of an instrument associated with a company comprising the steps of:
providing a computer adapted to store information about at least one specified event which a company may experience during a predefined future time period;
storing at least one specified event on the computer;
including a first claim on the company at a first seniority level attendant to a financial instrument being associated with the predefined future time period and with one or more events which the company may experience during the period;
upon one of the specified events occurring during the period, providing for the transformation of the first claim to a predefined second claim having a second seniority level lower than the first seniority level;
obtaining a statistical model of the likelihood of occurrence of the specified event or events; and
deriving the value of the instrument using a statistical model and respective values of the first and second claims.

10. A computer system for establishing a value of an instrument associated with a company comprising the steps of:
providing a computer adapted to store information about at least one specified event which a company may experience during a predefined future time period;
storing at least one specified event on the computer;
including a first claim on the company at a first seniority level attendant to a financial instrument being associated with the predefined future time period and with one or more contingent events which the company may experience during the period;
upon one of the specified events occurring during the period providing for the transformation of the first claim to a predefined second claim having a second seniority level lower than the first seniority level;
providing a statistical model of the likelihood of occurrence of the specified event or events; and
deriving the value of the instrument using the statistical model and respective values of the first and second claims.
